(19) United States
(12) Patent Application Publication
(10) Pub. No.: US 2024/0158589 A1
(43) Pub. Date: May 16, 2024

(54) HEAT STABILIZED MEMBRANE

(71) Applicant: Celgard, LLC, Charlotte, NC (US)

(72) Inventors: Eric R. White, Fort Mill, SC (US); David Anzini, Fort Mill, SC (US); Ron E. Smith, Huntersville, NC (US)

(21) Appl. No.: 18/280,227

(22) PCT Filed: Mar. 1, 2022
(86) PCT No.: PCT/US2022/018236

§ 371 Date: Sep. 3, 2023

Related U.S. Application Data
(60) Provisional application No. 63/156,981, filed on Mar. 5, 2021.

(51) Int. Cl. C08J 5/18; B01D 67/00; B01D 69/02; B01D 71/26; B01D 71/76; B32B 5/02; B32B 27/12; B32B 27/32

(52) U.S. Cl. CPC C08J 5/18; B01D 69/02; B01D 71/261; B01D 71/262; B01D 71/76; B32B 5/02; B32B 27/12; B32B 27/32; B01D 67/0027; B01D 67/0088; B01D 2325/22; B01D 2325/30; B32B 2255/10; B32B 2270/00; B32B 2307/308; B32B 2307/516; B32B 2307/518; B32B 2307/714; B32B 2437/00; B32B 2571/00; C08J 2323/16; C08J 2423/12

(57) ABSTRACT

A dry-process porous membrane having an oxygen induction time (OIT) greater than 3 minutes, greater than 5 minutes, greater than 10 minutes, greater than 15 minutes, greater than 20 minutes, or greater than 25 minutes where OIT is measured at 215° C. and 100% O₂. The dry-process porous membrane may be a microporous polyolefin membrane.

### RELATED APPLICATIONS

This application is a 371 Application to PCT Application No. PCT/US2022/018236, filed Mar. 1, 2022, which claims priority to U.S. Provisional Application No. 63/156,981, filed Mar. 5, 2021, which are incorporated herein by reference in their entireties.

### FIELD OF INVENTION

This application is directed to porous membranes or coated porous membranes exhibiting excellent heat stability. The porous membranes or coated porous membranes disclosed herein may be microporous. The porous membranes or coated porous membranes may be used as battery separators, textiles, or in other applications where heat stability is desirable.

### BACKGROUND OF INVENTION

Oxidation resistance is an important property of membranes that may be exposed to heat. This includes membranes used as battery separators, textiles, or in other applications where heat stability is desirable. For example, membranes used in a textile may be exposed to hot dryers, autoclaves, or the like. Oxidation occurs more rapidly in such environments. As oxidation proceeds, heat accumulates on garments faster than it can be dissipated, and eventually, the membranes may be ignited and burn.

One known method for improving oxidation resistance of membranes used in textile applications is to coat the membrane with an antioxidant coating. However, this solution may lower the breathability of the membrane if the coating blocks the pores of the membrane.

Thus, a solution where oxidation resistance is improved and breathability is maintained is desirable.

### SUMMARY

In one aspect, what is disclosed is a dry-process porous membrane having an oxygen induction time (OIT) greater than 3 minutes, greater than 5 minutes, greater than 10 minutes, greater than 15 minutes, greater than 20 minutes, or greater than 25 minutes where OIT is measured at 215° C. and 100% O₂.

In some embodiments, the membrane may comprise a polyolefin homopolymer, a polyolefin copolymer, a polyolefin terpolymer, or combinations thereof.

In some embodiments, the membrane may be a uniaxially stretched or biaxially stretched.

The membrane, in some embodiments, may comprise one or more secondary antioxidants.

The membrane, in some embodiments, may further comprise an antioxidant-containing coating on at least one side thereof.

In another aspect, what is described is a composite. The composite comprises: (1) the dry-process porous membrane described herein; and at least one selected from a fabric, a woven, a non-woven, a mesh, or combinations thereof. The composite may have a 2-layer, 2.5-layer, or 3-layer construction.

In another aspect, a garment is described. The garment comprise the dry-process porous membrane described herein.

### DESCRIPTION OF DRAWINGS

FIG. 1A and FIG. 1B are SEMS of membranes described herein.

FIG. 2 is an SEM of a membrane as described herein.

FIG. 3 is a graph showing oxygen induction time according to some embodiments described herein.

### DESCRIPTION

### Porous Membrane

A porous membrane that is at least one of heat-stabilized and oxidation resistant is described herein. This may mean that the porous membrane exhibits an oxygen induction time (OIT) greater than 3 minutes, or preferably greater than 5 minutes, greater than 10 minutes, greater than 15 minutes, greater than 20 minutes, or greater than 25 minutes.

In some preferred embodiments, the porous membrane is nanoporous, mesoporous, macroporous, or microporous. In some particularly preferred embodiments, it is microporous. The porous membrane may have an average pore size from 0.01 to 1 micron, from 0.01 to 0.9 microns, from 0.01 to 0.8 microns, from 0.01 to 0.7 microns, from 0.01 to 0.6 microns, from 0.01 to 0.5 microns, from 0.01 to 0.4 microns, from 0.01 to 0.3 microns, from 0.01 to 0.2 microns, or from 0.01 to 0.1 microns. The membrane may have a thickness from 5 to 50 microns, from 5 to 40 microns, from 5 to 30 microns, from 5 to 25 microns, from 5 to 20 microns, from 5 to 15 microns, or from 5 to 10 microns.

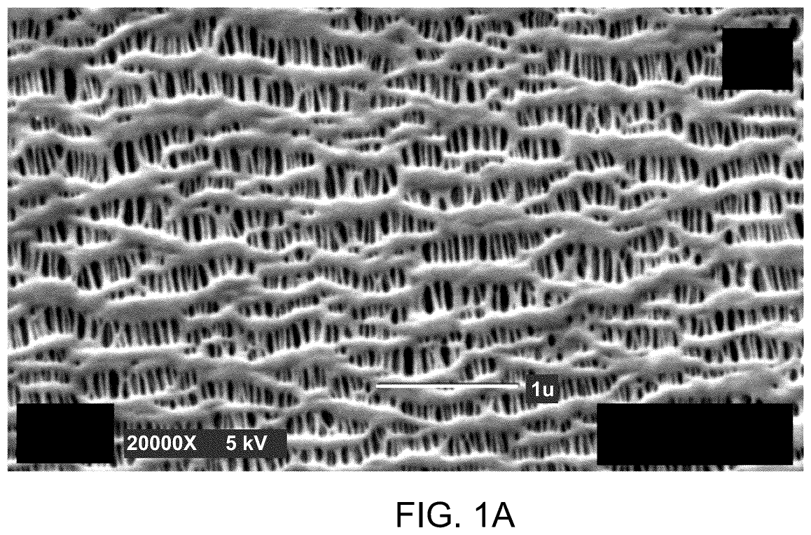

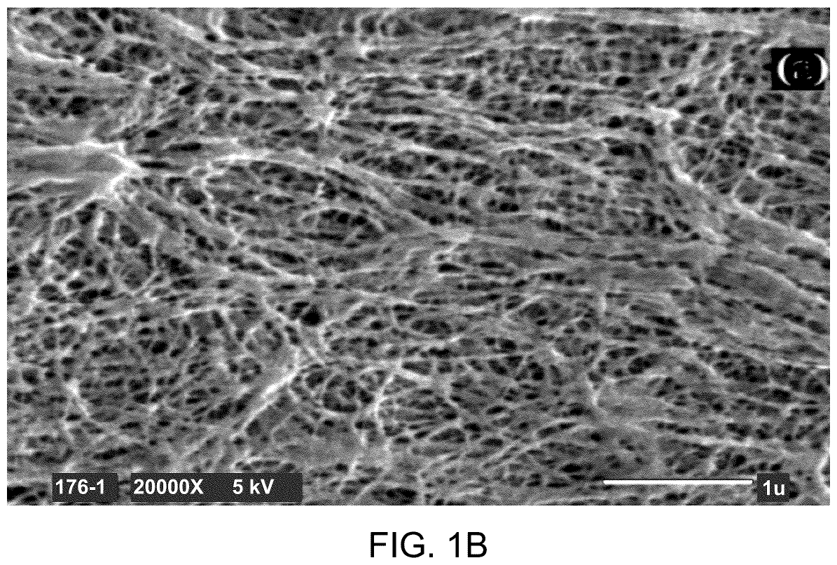

In some preferred embodiments, the porous membranes is made by a dry-process which, as would be understood by a skilled artisan, means that the process used to form the membrane does not utilize solvents or oils to form the pores. Films formed by a dry-process have a distinct structure compared to membranes formed by a wet process. For example, FIG. 1A shows a dry-process membrane (made using the Celgard® dry-stretch process), and FIG. 1B shows a wet process membrane.

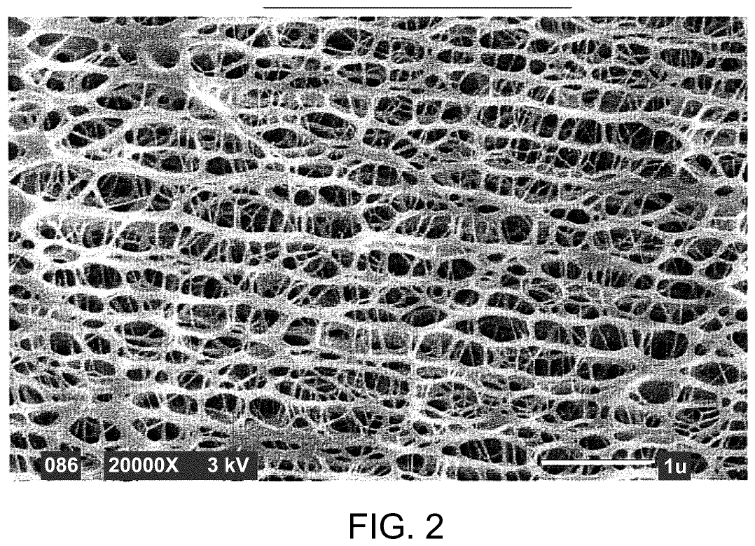

As understood by those skilled in the art, in a dry-process, pores may be formed by stretching. A dry process may also use particles, including inorganic particles, to facilitate the formation of pores, but this is not required. In fact, in a preferred embodiment, the membrane is formed using a dry-process such as the Celgard® dry-stretch process, which does not typically utilize particles. Membranes made with and without particles will have different structures. When the membrane is made using a dry-process such as the Celgard® dry-stretch process, the membrane is uniaxially (e.g., in the machine direction or MD) or biaxially (e.g., in the MD and transverse direction (TD)). Uniaxially and biaxially stretched membranes will have different structures. For example, a uniaxially stretched membrane may look like the membrane in FIG. 1A, while a biaxially stretched membrane may look like the membrane in FIG. 2.

The polymer used to form the porous membrane described herein is not so limited. Any polymer capable of forming a porous film using a dry-process may be used. In some preferred embodiments the polymer may be a polyolefin, a blend of two or more polyolefins, or a blend of a polyolefin and a non-polyolefin. For example, the polymer may be a polyolefin homopolymer, polyolefin copolymer, a polyolefin copolymer, or combinations thereof. For example the polymer may comprise, consist of, or consist essentially of the following: a polyolefin homopolymer; a polyolefin copolymer; a polyolefin terpolymer; a blend of a polyolefin homopolymer and a polyolefin copolymer; a blend of a polyolefin homopolymer and a polyolefin terpolymer; a blend of a polyolefin copolymer and a polyolefin terpolymer; or a blend of a polyolefin homopolyer, a polyolefin copolymer, and a polyolefin terpolymer. For example, in some embodiments, the polymer used to form the membrane may include a blend of a polypropylene homopolymer and a polyethylene-polypropylene copolymer. In some embodiments, the polymer may include only a polyethylene-polypropylene copolymer.

In preferred embodiments, the polymer used to form the porous membrane also includes added antioxidants such as primary or secondary antioxidants. In particularly preferred embodiments, the added antioxidants comprise, consist of, or consist essentially of secondary antioxidants or antioxidants that act as both primary and secondary oxidants. Secondary antioxidants, as understood by those skilled in the art, are different from primary antioxidants which may be added by polymer manufacturers so that the polymers can be effectively extruded, which involves the application of heat to soften or melt the polymer. Exemplary secondary antioxidants may include phenolic antioxidants, sulfur-containing antioxidants, hindered phenols, thioethers, and the like. An amount of added secondary antioxidant (or antioxidant that is primary and secondary) may be in a range from 500 ppm to 5,000 ppm, from 600 ppm to 5,000 ppm, from 700 ppm to 5,000 ppm, from 800 ppm to 5,000 ppm, from 900 ppm to 5,000 ppm, from 1000 ppm to 5,000 ppm, from 1100 ppm to 5,000 ppm, from 1200 ppm to 5,000 ppm, from 1300 to 5,000 ppm, from 1400 ppm to 5,000 ppm, from 1500 to 5,000 ppm, from 2,000 ppm to 5,000 ppm, from 2,250 ppm to 5,000 ppm, from 2,500 ppm to 5,000 ppm, from 2750 ppm to 5,000 ppm, from 3,000 ppm to 5,000 ppm, from 3250 ppm to 5,000 ppm, from 3,500 ppm to 5,000 ppm, from 3750 ppm to 5,000 ppm, from 4,000 ppm to 5,000 ppm, from 4250 ppm to 5,000 ppm, from 4500 ppm to 5,000 ppm, or from 4750 ppm to 5,000 ppm.

The porous membrane may be alone or in combination with other membranes, layers, coatings, treatments, or the like.

In some embodiments, the porous membrane may be used as or as part of the following: a battery separator, a filter, a textile, a capacitor, or the like.

### Composite

The porous membrane described herein may be used alone or may be part of a composite material. In some embodiments, a composite comprising the membrane and at least one other layer is disclosed. The additional layer may be, for example, a mesh, a woven, a non-woven, a fabric, or the like. In some embodiments, the composite may have a 2-layer, 2.5 layer, 3-layer, 3.5 layer, 4-layer, 4.5 layer, or 5-layer construction. In some embodiments, the composite may have more than 5 layers. As understood by those in the art, the constructions with half-layers include an applied partially protective layer that may be applied, for example, by printing, spraying, or similar techniques.

### Garment of Equipment

A garment or equipment may comprise the membrane or composite described herein.

A garment is not limited, and may include, shirts, hats, pants, socks, undergarments, which includes diapers and feminine products, shoes, coats, gloves, scarves, skirts, shorts, and the like.

The equipment is not so limited, but in preferred embodiments may include personal protective equipment (PPE). The PPE is not so limited and may be at least one of reusable, disposable, and recyclable.

Examples of personal equipment that may be formed using the membranes or composites disclosed herein include, but are not limited to a mask, a hat, a surgical cap, gloves, a hospital gown, scrubs, a jacket, a surgical shoe cover, a hazmat suit, a blanket, a surgical drape, a laboratory coat, coveralls, a privacy curtain, a vest, an apron, a chemical protective suit, and a full body suit. Examples of alternative personal protective equipment include the following: a shower curtain; a car seat; a booster seat; an automotive fabric; an automotive seat cover; upholstery or furniture fabric; outdoor furniture fabric; material for an outdoor furniture cover; a pillow; baby gear including pack-and-plays, basinetts, portable cribs, or co-sleepers; a car, vehicle, or bike cover; an umbrella; an awning; a tent; a tarp; decorative wall fabric; decorative cubicle fabric; wall coverings; floor coverings; window coverings; rugs; HVAC filters; and air filters.

### Examples

Inventive Example 1 (1125 ppm)—A microporous membrane was formed using the Celgard® dry-stretch process from a polymer mixture comprising about 99% polypropylene-polyethylene copolymer, about 1% polypropylene homopolymer, an a secondary antioxidant in an amount of 1125 ppm. The homopolymer acted as a carrier for the antioxidant. More homopolymer could be used, but it was not here.

Inventive Example 2 (2250 ppm)—A microporous membrane was formed using the Celgard® dry-stretch process from a polymer mixture comprising about 99% polypropylene-polyethylene copolymer (same as used in Inventive Example 1), about 1% polypropylene homopolymer (same as Inventive Example 1), an a secondary antioxidant in an amount of 2250 ppm. The homopolymer acted as a carrier for the antioxidant. More homopolymer could be used, but it was not here.

Comparative Example (0 ppm)—A microporous membrane was formed using the Celgard® dry-stretch process from a polymer mixture comprising about 100% polypropylene-polyethylene copolymer (same as used in inventive Examples). 0 ppm of secondary antioxidant was added.

For each example above, oxygen induction time (OIT) was measured after extrusion when the extrudate is nonporous, after machine direction (MDO) stretching, and after machine direction (MDO) and transverse direction (TDO) stretching.

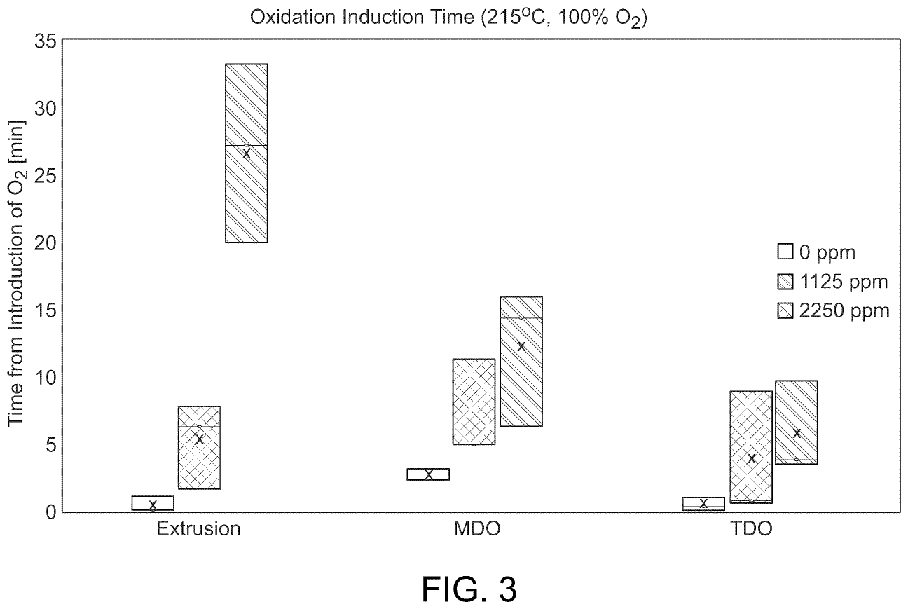

Oxygen induction time (OIT) of each porous membrane sample was measured using differential scanning calorimetry (DSC) according to a method as follows: (1) a sample of porous membrane is heated in a chamber under nitrogen (N₂) at a rate of 10° C./minute until the test temperature of 215° C. is reached; (2) sample is held for 2 minutes at the test temperature of 215° C. under nitrogen (N₂); Change atmosphere to 100% oxygen (O₂) while holding at the test temperature of 215° C., and then start to measure time. OIT is the average time it takes, from the start, for heat flow to the chamber to turn negative for the first exothermic peak after changing the atmosphere. OIT for each sample at each stage is shown in FIG. 3. “Extrusion” indicates the OIT of the non-porous extrudate for each example, “MDO” indicates the OIT of each example after machine direction stretching to form pores for each example, and “TDO” indicates the OIT after machine direction and transverse direction stretching of each sample. Results are shown in FIG. 3.

In accordance with at least selected embodiments, aspects or objects, there is provided or contemplated a possibly preferred dry-process porous membrane having an oxygen induction time (OIT) greater than 3 minutes, greater than 5 minutes, greater than 10 minutes, greater than 15 minutes, greater than 20 minutes, or greater than 25 minutes where OIT is measured at 215° C. and 100% O₂. The dry-process porous membrane may be a microporous polyolefin membrane.

In accordance with at least certain possibly preferred embodiments, aspects or objects, there is provided or contemplated porous membranes or coated porous membranes exhibiting excellent heat stability, such porous membranes or coated porous membranes may be microporous, and such possibly microporous membranes, porous membranes or coated microporous or porous membranes may be used as battery separators, textiles, or in other applications where heat stability is desirable.

1-25. (canceled)

26. A dry-process porous membrane having an oxygen induction time (OIT) greater than 5 min, where OIT is measured at 215° C. and 100% O₂.

27. The dry-process porous membrane of claim 26, wherein the OIT is greater than 10 min.

28. The dry-process porous membrane of claim 26, wherein the OIT is greater than 15 min.

29. The dry-process porous membrane of claim 26, wherein the OIT is greater than 20 min.

30. The dry-process porous membrane of claim 26, wherein the OIT is greater than 25 min.

31. The dry-process porous membrane of claim 26, wherein the membrane comprises a polyolefin homopolymer, a polyolefin copolymer, a polyolefin terpolymer, or combinations thereof.

32. The dry-process porous membrane of claim 31, wherein the membrane comprises a polyolefin homopolymer.

33. The dry-process porous membrane of claim 31, wherein the membrane comprises a polyolefin copolymer.

34. The dry-process porous membrane of claim 31, wherein the membrane comprises a polyolefin homopolymer and a polyolefin copolymer.

35. The dry-process porous membrane of claim 31, wherein the membrane comprises a polyolefin terpolymer.

36. The dry-process porous membrane of claim 31, wherein the membrane comprises a polyolefin homopolymer and a polyolefin terpolymer.

37. The dry-process porous membrane of claim 31, wherein the membrane comprises a polyolefin homopolymer, polyolefin terpolymer, and a polyolefin copolymer.

38. The dry-process porous membrane of claim 31, wherein the membrane comprises a polyolefin terpolymer and a polyolefin copolymer.

39. The dry-process porous membrane of claim 26, wherein the membrane is uniaxially stretched.

40. The dry-process porous membrane of claim 26, wherein the membrane is biaxially stretched.

41. The dry-process porous membrane of claim 26, wherein the membrane comprises one or more secondary antioxidants.

42. The dry-process porous membrane of claim 26, further comprising an antioxidant-containing coating on at least one side thereof.

43. The dry-process porous membrane of claim 41, further comprising an antioxidant-containing coating on at least one side thereof.

44. A composite comprising:
the dry-process porous membrane of claim 26; and
at least one selected from a fabric, a woven, a non-woven, a mesh, or combinations thereof.

45. The composite of claim 44, having a 2-layer, 2.5-layer, or 3-layer construction.

46. A garment comprising the composite of claim 44.

47. A garment comprising the dry-process porous membrane of claim 26.

48. A personal protective equipment comprising the composite of claim 44.

49. A personal protective equipment comprising the dry-process porous membrane of claim 26.

50. The dry-process porous membrane of claim 26, wherein the membrane is 40 or more, 50 or more, or 60 or more inches wide.
